(19) United States
(12) Patent Application Publication
(10) Pub. No.: US 2006/0174346 A1
(43) Pub. Date: Aug. 3, 2006

(54) INSTRUMENTATION FOR ALARMING A SOFTWARE PRODUCT

(75) Inventors: Nicholas M. Carroll, Los Angeles, CA (US); Philip Lieberman, Beverly Hills, CA (US); Jotham Schwartz, Topanga, CA (US); Jason A. Fredrickson, Los Angeles, CA (US)

Correspondence Address: INTELLECTUAL PROPERTY LAW OFFICES, 1901 S. BASCOM AVENUE, SUITE 660, CAMPBELL, CA, 95008, US

(73) Assignee: LIEBERMAN SOFTWARE CORPORATION, Beverly Hills, CA (US)

(21) Appl. No.: 10/906,028

(22) Filed: Jan. 31, 2005

(51) Int. Cl. H04N 7/16

(52) U.S. Cl. 726/26

(57) ABSTRACT

An instrumentation for alarming a software product (210) that is subject to a license (108). An alarm client (212) is incorporated with the software product to collect usage information about the software product while it runs on a computer. This usage information permits determining whether the software product is being used in accord with the license. The alarm client further communicates an activity message (224) including the usage information to a remote server (214) via a communications network (220).

### TECHNICAL FIELD

The present invention relates generally to electrical computers and digital processing systems, and more particularly to apparatus, means, and steps for increasing the protection of software from unauthorized use by an end user.

### BACKGROUND ART

Software piracy, the unlicensed copying and use of software, is a serious concern today worldwide. Among the many problems that it presents are economic, moral, legal, and governmental ones that increasingly beg a solution. To most software product manufactures, software piracy represents a huge economic loss that they must unfairly pass on to honest customers. To our leaders, particularly including parents, software piracy represents a seductive lure that entices the morally challenged and rewards lawlessness. At a higher level of leadership, software piracy represents a breakdown in the very structure of law that our governments create and strive to maintain. As just one example of this, it is notable that the efforts of major governments to control the proliferation of software deemed threatening to national security interests have been effectively thwarted by software piracy and its perpetrator's near total disregard for national boundaries.

FIG. 1 (background art) is a block diagram providing an overview of the current situation. A software manufacturer 100 creates a software product 102 that it then distributes to users 104. Typically the product 102 is sold to the users 104 (i.e., they are customers), and revenue 106 flows back to the manufacturer 100 from this. Of particular present interest, the manufacturer 100 will typically grant the various users 104 one or more types of licenses 108 to use the product 102. Other business models are possible, for instance, where the product 102 is distributed for free, and then only properly or fully operates with advertising being presented to the users, and then the providers of the advertising pay the manufacturer. In general, however, the scheme represented in FIG. 1 serves for this discussion.

Unfortunately, some users 104 may take the product 102 and do things outside the scope of their licenses 108, defrauding the manufacturer 100 and effectively making these users 104 a subcategory of infringers 110 (discussed presently). FIG. 1 stylistically depicts a number of representative situations. The preferred situation is represented by user 104a, which uses the product 102 in complete accord with their license 108. Of course, the goal is to have all or most users 104 be users 104a.

A common present situation is depicted by user 104b, which uses the product 102 in a manner that exceeds a numerical limitation in their license 108. For example, the license 108 may include a term permitting use of the product 102 on one computer and the user 104b may install and use the product 102 on eight computers. Or the license 108 may permit use of the product 102, for instance, to make exact bit-by-bit duplicates for disaster recovery purposes of one storage device. The user 104b may then install the product 102 on one computer, use it on a storage unit there, then uninstall the product 102 from that computer and then install the product 102 on a different computer and use it on a storage unit there, etc. Or the license 108 may permit using the product 102 for 10,000 transactions per month and the user 104b may instead use it for 100,000 transactions per month. The types of license infringement that our hypothetical user 104b is engaged in here are all forms of fraud against the manufacturer 100 that are often termed “under licensing.” To simplify this discussion we include under licensing within our general definition of software piracy.

Yet another situation, albeit a more rare one, is depicted by the user 104c, which uses the product 102 in a manner that exceeds a different type of limitation in their license 108. For instance, the product 102 may include features (e.g., strong encryption capabilities) that are subject to government export restrictions and the user 104c may send otherwise license-compliant copies of the product 102 to its subsidiaries or employees in other countries. Upon discovering this, a government may then take action against the previously unknowing and well-intended manufacturer 100, such as imposing odious reporting requirements on all future sales. Alternately, the manufacturer 100 may grant the license 108 to the user 104c with an exclusion prohibiting the use of the product 102 in medical systems and the user 104c may nonetheless go ahead and breach that term of the license 108 by installing it in critical systems in hospitals. The well-intended manufacturer 100 can then, unexpectedly, find themselves embroiled in expensive litigation involving the medical systems and the injuries or deaths of sympathetic parties. Terming this form of software piracy a “fraud” against the manufacturer 100 is semantically awkward, but it nonetheless is such and it often is serious and needs to be detected and stopped. To simplify this discussion we also include out-of-scope licensing within our general definition of software piracy.

Some more insidious forms of software “piracy” are depicted being engaged in by user 104d and user 104e, which provide copies of the product 102 to non-licensed parties. The case where the product 102 includes trivial or simply no protection mechanisms, is represented by the user 104d, who simply passes copies of the product 102 on to one or more infringers 110 who likely have no direct relationship with the manufacturer 100. This case is important, but for present purposes is largely subsumed into that of the user 104e. That is, any remedy for the case presented by user 104e will likely also address the case of user 104d.

At this point some categorizations becomes useful. The users 104b-d are, of course, infringing the rights of the manufacturer 100. We can categorize the users 104b-d generally as infringers 110 and we more specifically label them infringers 110a here, to clarify that they are themselves, directly defrauding the manufacturer 100. The case of the user 104d, however, introduces another type of infringer 110, infringers 110b that have no direct relationship with the manufacturer 100. This distinction is important elsewhere in this discussion.

Continuing with FIG. 1, the product 102 delivered to the user 104e includes a protection or anti-piracy mechanism 112. Such mechanisms 112 are increasingly common today, to thwart infringers 110a like the user 104d. When user 104e provides copies of the product 102 to non-licensed parties the anti-piracy mechanism 112 is designed to prevent those copies from being usable. As discussed presently, however, such mechanisms 112 are not perfect and a hacker 114 can often circumvent them.

This brings us to the last party shown in FIG. 1, the software pirate 116. The pirate 116 and the hacker 114 and the user 104e may all be one in the same person; or these may all be separate parties, potentially located in separate countries and communicating indirectly or even anonymously through intermediaries. In the current rampant software piracy environment, many such combinations of roles and variations are common.

The motivations of the infringers 110, hackers 114, and pirates 116 can vary. One common motive is to gain economic benefit by selling pirated copies of the product 102 or by selling information or tools for circumventing the anti-piracy mechanisms 112. Alternately, for example, the user 104e may provide a copy of the product 102 to the hacker 114 out of friendship; the hacker 114 may crack the anti-piracy mechanism 112 as an intellectual challenge, and then publish their results in a public forum; and the pirate 116 may take (“steal”) those results and more widely circulate them for money or barter (e.g., other software, crack keys, etc., to increase their personal ill-gained “inventory). Considering the possible motivations of all of the various parties engaged in all of the possible variations of software piracy is far too much to cover in this discussion, and is simply not germane. What is important for here is that the unlicensed copying and usage of software, i.e., software piracy, is occurring widely and in the current scheme of things there has until now been no effective way to remedy that.

As already alluded to in passing, software manufacturers have considerable incentive to combat software piracy. With the cost for large-scale deployment of many high-end software products today exceeding tens or hundreds of thousands of dollars, for example, there is usually a very significant financial incentive to protect sales. Most software piracy is therefore combated today by the manufactures with key-generation and key-verification schemes.

In key-generation a set of keys, often termed “license keys,” is generated by the software manufacturer using a “secret” key-generation algorithm that encodes information into a proprietary format to create a random-appearing sequence of digits. The software and one or more such license keys for it are then distributed to the intended users of the software. The software and the license keys may travel together or separately, and today both are often distributed electronically.

The current state of the art in key-generation is the use of digitally signed, “node-locked” license keys. These encode the IP address, NetBIOS name, MAC address, or another identifier of the computer on which the software is to be used. Other pertinent information may also be included in the license key, such as usage information like the duration of the license, the number of permitted users, the number of permitted transactions, etc. Additionally, a checksum may be included in a license key, particularly if usage limitation type information is included.

Using different types of identifying information to node-lock a key has various ramifications, as outlined in the partial listing of machine identifiers in TBL. 1.

TABLE 1

| Identifier | Benefits | Drawbacks |
|---|---|---|
| IP Address | NetBIOS names are easily | IP Addresses are often |
| | determined by the end | dynamically assigned, and |
| | user | change automatically |
| NetBIOS Name | NetBIOS names are easily | NetBIOS names are easily |
| | determined by the end | changed |
| | user | |
| MAC Address | Locks the key to a specific | A new key must be |
| | piece of network hardware | generated for every new |
| | | network card used |
| | | Not every machine has a |
| | | network card |
| | | Often difficult to retrieve |
| Hard Drive | Locks the key to a specific | Often difficult to retrieve |
| Serial Number | piece of storage hardware | A new key must be |
| | | generated for every new |
| | | hard drive used |

In key-verification, the software requires the user to enter the license key, any digital signatures are authenticated, any checksums are checked, and the key information is decoded and verified. In general, the goal here is to confirm that the software is in fact running on the appropriate computer and, to the extent practical, that it is running within the scope of the granted license.

If the software determines that it is being run in violation (breach) of the license, it may take various actions. One such action, termed by some software licensing professionals the “brick wall” approach, is for the software to simply stop executing. Another such action, often termed the “speed bump” approach, is for the software to inform (e.g., “nag”) the user that the software is being used improperly. The speed bump approach is sometimes configured to escalate into the brick wall approach.

However, all of this seemingly sophisticated technology is still frequently insufficient to stop piracy. Just as the software manufacturers have an incentive to employ anti-piracy mechanisms to protect their products, the desirability of those products often provides infringers and software pirates with a counter incentive to seek out or provide ways to thwart the anti-piracy mechanisms.

The reverse-engineering of license key schemes to produce “crack keys” is relatively easy, and widely engaged in by a subclass of hackers commonly termed “crackers.” As a result, combating software piracy has evolved into an “arms race” between the software manufacturers and the software pirates. In this war, wherein the crackers are often better-equipped than the software manufacturers, each new revision of a key-generation and key-verification scheme may be reverse-engineered in a matter of hours or days of its being introduced.

Such reverse-engineering of key-generation and key-verification schemes is possible because there often are flaws in even the most rigorous schemes attempted. For example, many opportunities exist because the software products necessarily run in-memory on the non-secure computers of the end users. These computers may easily end up under the direct control of crackers who are able to run the software in debugging environments, allowing them to inspect the contents of the memory used by the software and to trace through its compiled code with ease. Approaches such as this work very well against software-based security, and have even successfully been used to circumvent “dongles”—hardware-based encryption systems that test to see if unique hardware in the dongle is present before allowing the software to run. By finding the parts of the software code that access any software or hardware protection mechanisms, and disabling those portions, most such protections can be eliminated.

Similarly, the “secret” algorithms used for encoding and decoding of license keys often cannot be kept secret, because the software runs on non-secure computers and this facilitates determining the algorithms. Thus, it often takes less time today to reverse-engineer most such algorithms than it takes to create them in the first place. Also similarly, symmetric cryptosystems cannot viably be used to sign license keys, because the keys can then easily be found out.

Another point of vulnerability often exists at key-verification, since only one check for a valid license key is usually ever performed. Once a valid appearing key has been entered into a software product it usually is stored on the local computer and used for all future activations of the software. This means that an infringer can enter a functional crack key once and thereafter be able to use the software product as many times as he or she desires. The window of opportunity to detect or catch infringing usage is therefore very small, because once a key has been accepted the software will function identically to a non-infringing installation.

This use of only a one-time check also poses another problem when confronted with malicious adversaries who attempt to modify the code of a software product to subvert any license checking functions that it contains. Because license verification code is typically run at the beginning of a normal usage session, it is relatively simple to find and excise this code through a “crack patch” or “trainer.” Such programs disable the licensing functionality of a software product by modifying its binary executable form to eliminate only some of the code. If the licensing code is the first executable code in the binary file, for instance, it is thus relatively simple to locate and remove or circumvent it.

As noted in passing above, any usage information (e.g., limitations with respect to the license from the manufacturer) is usually included in the license key itself. This information can, for example, be configured to instruct the software to deactivate itself if the user exceeds their license parameters. For instance, a software product might have a defined licensed lifespan, where the licensee is permitted to use the software only for a short time. This is a common and very desirable scenario in the case of demonstration licenses. The license key here would then typically contain start and stop dates for the license. However, by simply creating a crack key with an effectively unlimited licensed lifespan parameter, the usage-monitoring code is circumvented and rendered useless. Alternately, the same result is achieved by excising such usage-monitoring code from the software product.

Containing usage information for the license key itself also has a more subtle disadvantage. Because the code used to interpret this information and to compare it to actual usage must be packaged with the software product, it is usually difficult to ensure that the software can accurately account for the broad range of situations that licensees will encounter. Thus, a particular customer might actually be using the software legally, but in a fashion that triggers the usage limitations. For example, the customer might change the IP address of the machine they are running the software product on. The new IP address would not match the IP address contained in the license key, and the software would be disabled. Conversely, an infringing user might be using the software entirely within the bounds of their license key (crack key or otherwise, as described above). For example, the manufacturer might grant a license with an exclusion prohibiting the use of the product in medical systems. Since computers running medical software are effectively identical to computers not running medical software, there is no way for the software product to determine whether or not the user is violating this exclusion. As a result, key-generation and key-verification has a high incidence rate of failure—either inconveniencing a legitimate customer or allowing an illegitimate user to execute the software product.

### DISCLOSURE OF INVENTION

Accordingly, it is an object of the present invention to provide an improved system to detect software piracy.

Briefly, one preferred embodiment of the present invention is an instrumentation for alarming a software product that is subject to a license. An alarm client is incorporated with the software product. This alarm client then collects usage information about the software product as it runs on a computer, wherein this usage information permits determining whether the software product is being used in accord with the license. The alarm client further communicates an activity message including the usage information to a remote server, via a communications network.

An advantage of the present invention is that it can perform effective authentication of a license away from the software product under that license, making the determinative authentication instead on a separate system (e.g., at a secure server owned and maintained by the software manufacturer).

Another advantage of the invention is that it can repeatedly authenticate the license on a regular basis, keeping any period of infringing use short rather than indefinite, and particularly catching fraud-based forms of infringement.

Another advantage of the invention is that it flexibly permits case-by-case analysis to determine whether a particular use of a software product is an infringing one, as well as more in-depth analysis as to the nature, scope, and patterns of such.

And another advantage of the invention is that it does not rely on the widely subscribed-to fallacy that a “secret” license generation algorithm is possible. Rather, the invention embraces the inevitable lack of secrecy in such, accepts that such will certainly fail in the face of determined reverse-engineering, and turns this a weakness of prior art approaches into an advantage to ultimately ensnare software pirates.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended tables and figures of drawings in which:

TBL. 1 is a partial listing of common machine identifiers used by prior art node-lock key-based approaches to combating software piracy.

FIG. 1 (background art) is a block diagram providing an overview of the current software piracy situation.

FIG. 2a depicts how a software alarming system can be viewed as having an instrumentation, monitoring, and action stages; and FIG. 2b depicts a top-level architecture for such a software alarming system in accord with the present invention.

FIG. 3 is a block diagram depicting how the alarm client of the software alarming system can be implemented with a communications, vault, evidence recorder, forensics, and state modules.

FIG. 4 is a block diagram depicting how the communications server of the software alarming system can be implemented with an event insertion, reply acquisition, and encryption modules.

FIG. 5 is a block diagram depicting how the database of the software alarming system can be implemented with a chronological event record, licensing information, organizational information, and response tables.

FIG. 6 is a block diagram depicting how the management server of the software alarming system can be implemented with a license management, associative logic, license violation determination, and loss recovery modules.

FIG. 7 is flow chart depicting a chronological overview of a process using the software alarming system in an exemplary usage scenario.

FIG. 8a-b depict how the alarm client of the software alarming system may be embodied as a state machine, wherein FIG. 8a is flow chart depicting how the states are selected and

FIG. 8b is a state diagram of the transitions between the modes.

In the various figures of the drawings, like references are used to denote like or similar elements or steps.

### BEST MODE FOR CARRYING OUT THE INVENTION

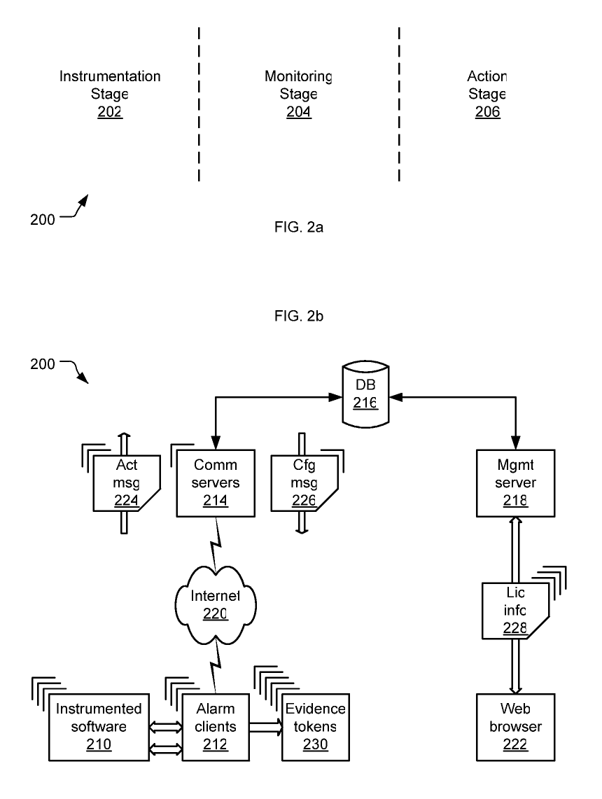

A preferred embodiment of the present invention is an instrumentation for alarming a software product. As illustrated in the various drawings herein, and particularly in the view of FIG. 2a-b, preferred embodiments of the invention are depicted by the general reference character 200.

After years of developing more and more complex lock and license key mechanisms for their own products, the inventors have come to appreciate that the conventional approaches to fighting software piracy are generally failures. In response to this, they have crafted a new approach that is termed “software alarming.”

FIG. 2a depicts how a software alarming system 200 can be viewed as having three major stages: an instrumentation stage 202, a monitoring stage 204, and an action stage 206; and

FIG. 2b depicts a top-level architecture for a software alarming system 200 in accord with the present invention.

In addition to the instrumented software 210, the software product that the software alarming system 200 monitors for infringement, the embodiment depicted here consists of four primary components: an alarm client 212, a communications server 214, a database 216, and a management server 218.

In particular, the alarm client 212 and the communications server 214 communicate via the public Internet 220, and other elements of the software alarming system 200 may do this as a matter of design choice. Of course, other communication mechanisms are possible and the spirit of the invention encompasses such variations irrespective of the communication system.

In very simple embodiments, the communications server 214, the database 216, and the management server 218 can all be integrated into one computerized system. In most anticipated embodiments, however, these will be in at least two separate systems that intercommunicate via the Internet 220 or a proprietary network.

The software manufacturer can access the management server 218 with a conventional web browser 222, thus permitting them to use and control the software alarming system 200 to achieve all of the instrumentation stage 202, the monitoring stage 204, and the action stage 206 cohesively with respect to the instrumented software 210.

As shown, the alarm client 212 is incorporated with a typical commercial software product to convert the product into the instrumented software 210. In operation, the alarm client 212 then locates, records, and communicates appropriate usage information as activity messages 224 to the communications server 214. Additionally, when so instructed by the communications server 214 with a configuration message 226, the alarm client 212 can deactivate or re-task the instrumented software 210. The alarm client 212 can also record evidence tokens 230 on the local machine to demonstrate that the instrumented software 210 was in fact executed, as well as the specific actions taken by the user with the instrumented software 210. The alarm client 212 thus is primarily responsible for the instrumentation stage 202 of the software alarming system 200.

The communications server 214 can be made the simplest component of the software alarming system 200, since it can be responsible only for receiving the activity messages 224, recording them into the database 216, and transmitting any configuration message 226 waiting in the database 216 back to the alarm client 212. This permits the communications server 214 to be implemented as a very lightweight and fast, stateless application. Optionally, the communications server 214 can augment the data in the activity messages 224 with additional data that it is well suited to provide. Some examples of this include adding a timestamp for when an activity message 224 was received and adding the IP address that the activity message 224 was received from.

The database 216 stores the activity messages 224 accumulated from the alarm client 212, stores any configuration messages 226 intended for the alarm client 212, and can store license information 228 about every license key and licensee known to the software manufacturer. The database 216 is accessed and updated by the communications server 214 and the management server 218.

The management server 218 will typically be the most advanced component of the software alarming system 200, at least next to the alarm client 212. As the information from the activity messages 224 accumulates, the management server 218 allows the software manufacturer to detect infringing usage of the instrumented software 210 through correlation and cross-referencing of that information with the license information 228. The management server 218 also allows the software manufacturer to place any configuration messages 226 intended for the alarm client 212 into the database 216, and to load the license information 228 into the database 216.

The management server 218 thus is primarily responsible for the monitoring stage 204 of the software alarming system 200, and is used by the software manufacturer to oversee the operations of the entire software alarming system 200. The management server 218 interfaces (by communicating with or being directly integrated with) the database 216.

As will become clear in the course of this discussion, the software alarming system 200 functions much like a home security alarm, by waiting until a crime has been committed and then informing the injured parties and, if desired, the appropriate authorities. Once an infringing usage has been confirmed, the data stream from the alarm client 212 can optionally be enhanced to transmit additional or particular identifying information about the user, the machine they are using, and the operations that are being performed while infringing. This enhanced collection of data can even be finely tailored to collect “just enough” evidence to provide a unique identity of the infringer as well as details of the commercial advantages that are being obtained by the infringing use of the software product. No attempt need be made to capture proprietary information of the user, such as passwords, database contents, credit card information, or other legally protected classes of data (e.g., in the United States, information covered under HIPPA, Sorbane-Oxley, and other Federal Laws that cover the handling of consumer information).

In marked contrast to the conventional approaches to combating software piracy, the software alarming system 200 can allow hackers to compromise license keys and other protection mechanisms of instrumented software 210 without the constant development of new key mechanisms. Using knowledge of the values of publicly available crack keys as well as other techniques detailed herein, the alarm client 212 embedded in or with an instrumented software 210 can intentionally allow it to continue running when compromised and, as a very consequence of its being compromised, for the alarm client 212 to transmit a stream of forensics data back to a communications server 214 that details the scope of infringement and the identities of those involved.

One major goal of software alarming system 200 is the accumulation of a body of evidence that can then be used for two, not necessarily exclusive, purposes. The evidence can be used to bring and prosecute a case in an appropriate court for copyright infringement, breach of license agreement, misappropriation of trade secret or commercial advantage, etc. Of more practical value to many software manufacturers, however, the evidence can be used when negotiating infringement settlements.

A common problem faced by software manufacturers prosecuting individuals and corporations for illegal usage of their software is an inability to prove infringement to the satisfaction of the infringer. Since the infringer faces negative consequences for admitting wrongdoing, the software manufacturer will likely face repeated denials and requests for more proof from any infringers they attempt to prosecute, regardless of the strength of basis for suspecting infringement.

Since the large amount of evidence typically collected by the software alarming system 200 can provide a compelling case for “willful and repeated infringement for commercial advantage,” potentially triggering very high damages under many statutes (e.g., Title 17 of the United States Code, the federal Copyright Act in the United States), many legal counsels are pragmatically willing to quickly settle cases brought by software manufactures when confronted with the facts that a corporate client has made infringing use of a software product. Often, the bulk of information presented to the counsels for the infringers detailing the infringement can result in the infringers admitting wrongdoing and seeking settlement even without formal litigation being initiated.

As a result, software manufacturers gain the ability to detect software piracy and, more importantly, they are provided with a defensible means to recover their otherwise lost revenue. Additionally, software alarming saves the manufacturers the ongoing expense of developing more and more complex and expensive license compliance systems.

Continuing again with both FIG. 2a-b, these also depict how the instrumentation stage 202 includes integration of the alarm clients 212 into the instrumented software 210, enabling it to then communicate the activity messages 224 back to a communications server 214. Ideally, each operation performed by an end-user with an instrumented software 210 results in an activity message 224 communicated to a communications server 214. As a practical matter, however, only a subset of particularly probative operations and events may be monitored for and reported on in the activity messages 224. Additionally, the alarm client 212 can be configured to report in an activity message 224 about inactivity with respect to one or more events.

When the instrumented software 210 is first activated on an end user's machine, it can immediately attempt to establish a connection with a communications server 214. This connection can then be periodically re-established throughout the period that the instrumented software 210 is active, allowing it to communicate operation events to the communications server 214. Once a connection has been established, the alarm client 212 reports the license key under which the instrumented software 210 has been activated, the registered owner and organization to which the machine running the software belongs, and other non-confidential information. Notably, the alarm client 212 need not ever never report any confidential, proprietary, or identifying information. For example, the login name of the user running the instrumented software 210 might be passed as a one-way hash value that would uniquely specify that user but would not allow the software manufacturer to identify the specific user by name.

One particular communications server 214 will generally be used by each alarm client 212, but which one out of potentially the many various ones that are provided may depend on field circumstances that cannot be predicted in advance. If an alarm client 212 encounters communications problems it can try using a different communications parameters, try using a different network or network segment, or simply try using a different communications server 214. An alarm client can also try increasing the frequency of attempts to send activity messages 224. As long as the instrumented software 210 is able to communicate with at least one of the communications servers 214, however, it can be left to continue running normally and as operations with the instrumented software 210 are attempted, report selected ones with the alarm client 212. This ensures both that the chronological record of activity is as accurate as possible and that the alarm client 212 (the “instrumentation”) cannot easily be circumvented. Along with the activity messages 224 being sent, the alarm client 212 can include a unique identification number that allows the communications servers 214 to correlate multiple activity messages 224 from separate runs of the instrumented software 210 on a same machine.

Once some measure of infringing use has been established, a communications server 214 can send a configuration message 226 instructing the alarm client 212 to enter an “enhanced” or “forensics” mode. In forensics mode, the alarm client 212 (or the instrumented software 210, if it has capabilities that the alarm client 212 can interface with to request this) inspects the local machine for identifying information and transmits it as part of the activity messages 224 to the communications server 214. This additional information then allows the software manufacturer to contact the infringing party or to report them to legal authorities or an industry association. The enhanced data stream sent in forensics mode may, for example, include user names, machine identification numbers, and other such pieces of information.

Any limitations here are not so much technical ones, but rather legal ones and matters of policy set by a software manufacturer. An instrumented software 210 need never report whether or not any operation was successful, simply that it was attempted. This can be used to prevent any sending of confidential information, while allowing the software manufacturer to establish a pattern of potentially infringing usage.

Because it is often critical that the rights of legitimate users not be infringed, the activity messages 224 to the communications servers 214 can be transmitted “in the clear”—that is, with no encryption or encoding whatsoever. This can allow legitimate users to inspect these messages and to ensure that none of their confidential or proprietary information is being transmitted without their approval.

An obvious problem that the alarm clients 212 face here is the ability to communicate with the communications servers 214, particularly in the face of the proliferation of firewalls in modern networks today. To solve this, the alarm clients 212 may use HTTP Post commands identical to those utilized by modern web browsers. This allows the alarm clients 212 to pass the activity messages 224 through firewalls unimpeded, on port 80. In the event that port 80 is unavailable, the same protocol can be used on other ports. Similarly, this allows passage of any configuration message 226 back from the communications servers 214 to the alarm clients 212.

FIG. 2a-b also depict how the monitoring stage 204 includes the accumulation and inspection of the chronologically recorded usage data from the activity messages 224 to detect when infringement of an instrumented software 210 has occurred. The usage information in the activity messages 224 transmitted by the alarm clients 212 is stored by the communications servers 214 in a database 216 that is accessible by the software manufacturer. The software manufacturer is then able to use business-logic rules to analyze the contents of the database 216 to determine whether or not infringement has occurred.

To facilitate analysis, the communications servers 214 can optionally enhance the activity messages 224 by adding timestamps, source network addresses, unique identification numbers, and any other useful information to them before storing them in the database 216. For example, a server-based tool such as SAM SPADE (a freeware network query tool on the Internet that has adopted the name of the fictional Dashiell Hammett detective) can be used to trace a source IP address to discover the present geographical location of an instrumented software 210 and the owner of the router from which an activity messages 224 originated.

To further facilitate analysis the software manufacturer can add license related information to the database 216, shown as the license information 228 in FIG. 2b. This license information 228 can include information about both valid and invalid license keys. That is, the license information 228 can specifically include license keys issued by the software manufacturer and presumed to still be valid, keys issued by the manufacturer and known to have been used invalidly, and keys not issued by the manufacturer (e.g., ones known to have been used invalidly or ones known to be functionally usable but not so far issued). To load the license information 228 and to later initiate analysis (which can be largely handled automatically) or to interactively perform analysis, the software manufacturer can employ a management server 218 and a conventional web browser 222.

Collectively, the information in the database 216 thus allows analysis to associate individual events by the instrumented software 210 with specific organizations and licensees. In some cases these entities can be cross-referenced with legal licensees and license keys, and in other cases the inability to do this will be a strong indication of infringement. Because network addresses can uniquely identify a given geographical location and network address owners are identified in public records, most users of the instrumented software 210 can be uniquely identified and their usage information extracted into a chronological record of activity. The license keys used in this record of activity can then be compared to the license keys issued to the licensee (or to a list of all generated legal keys, if the user is not a valid licensee) to determine whether or not a legal key is in use.

Clearly, if the key being used does not correspond to a legally issued key, infringement has occurred. However, as discussed above, there are other types of infringing usage, such as under-licensing, which may not be detected by this simple test. Detecting these types of infringement requires more advanced business logic which compares the information stored in the database 216 from the activity messages 224 to that from the license information 228.

The information in the license information 228 will typically include license limitations that the software manufacturer has set for specific organizations. For example, the most common type of fraud-based infringement is under-licensing, wherein a legally obtained key is used for many more copies of the software than originally specified. By comparing the number of computers from which activity messages 224 have originated to the number of computers permitted by a license, under-licensing can be accurately detected. Similar tests can be run for chronological limits (usage of the software outside of a defined license period), site limits (usage of the software away from a designated “site license” location), user limits (usage of the software by user IDs not listed in the license agreement), or tests against other business rules.

Because the alarm clients 212 typically communicate constantly with the communications servers 214, there is no need to perform this business logic in “real-time.” The software manufacturers can monitor the contents of the database 216 at their own pace, using the management server 218 and the web browser 222. Once a likely case of infringement is established, a configuration message 226 can then be stored in the database 216 for the next time that a particular alarm client 212 connects with a communications server 214. Upon connection to the database 216, the communications server 214 will then discover that there is configuration message 226 for it to reply back with to the alarm client 212. In this manner the alarm client 212 is instructed to enter the forensics mode to collect and send more extensive or detailed information. The use of the optional forensics mode allows the software manufacturer to be more accurate and explicit in establishing actual infringement and what its scope is with respect to the particular instrumented software 210.

Continuing further with FIG. 2a-b, once the instrumentation stage 202 and the monitoring stage 204 have identified a case of infringing usage of an instrumented software 210, the software manufacturer can take action to collect their lost revenues. Unlike the previous stages, which were passive, the action stage 206 refers to the use of the data in the database 216 to demonstrate infringing usage, to recover unpaid licensing fees or royalties or to seek a legal remedy.

The first step to recovering lost revenues can be to activate the already noted forensics mode of the alarm client 212 in the instrumented software 210. This is performed by instructing the communications server 214 to transmit a configuration message 226 to the alarm client 212, causing it to include additional information in the stream of activity messages 224 that it sends. This enhanced data stream typically includes additional identifying information like user name, machine name, organization name, and other such data. As with the normal data stream, the enhanced one need not contain any proprietary or confidential information. The alarm client 212 can collect the identifying information from data input by the user to the instrumented software 210 or from the operating system of their machine. The enhanced data stream can also contain additional usage information, for instance, information more specifically detailing how the infringement is occurring.

Once the enhanced data stream starts to arrive, the software manufacturer is able to start cross-referencing the additional information in it with information on known licensees, commercially available databases of address and telephone information, etc. This allows the software manufacturer to identify a point of contact for an organization committing the infringement. Because most economically injurious infringement is committed at the individual rather than the organizational level, making an organization's legal counsel aware that infringement has occurred is usually sufficient to stop the infringement and often to successfully negotiate a more satisfactory arrangement (e.g., a payment for the past infringing use and a purchase of appropriate licenses to allow continued use).

In the event that the infringing organization refuses to comply with the terms of the software manufacturer's license or to recognize and properly accord its legal rights, further steps can be taken by instructing the instrumentation package to “redirect” the end user to a specific web page (such as an informative page on the definition and consequences of software infringement), or to simply deactivate the instrumented software 210 and no longer allow it to function. These instructions can be sent to the alarm client 212 as identified by unique identification numbers, IP addresses, license keys, or any other form of identification.

A particular issue with software infringement is that it is often perpetrated by skilled individuals, i.e., crackers, who are highly knowledgeable about the computer systems that they maintain. As a result, when the software manufacturer displays a record of evidence demonstrating that infringement has occurred, these individuals or others in infringing organizations sometimes attempt to “cover their tracks” by uninstalling the instrumented software 210 or deleting any record of its existence, and then claim that the evidence record has been fabricated. To guard against this sort of behavior, a trail of evidence tokens 230 which illustrate without a doubt that the instrumented software 210 was in fact run on a machine can be left on the local machine in multiple locations and formats. If desirable, each activity message 224 that the alarm client 212 transmits to the communications server 214 can even be the basis of such an evidence tokens 230. These evidence tokens 230 can be invaluable in demonstrating conclusively to legal counsel that a particular individual has in fact committed infringement.

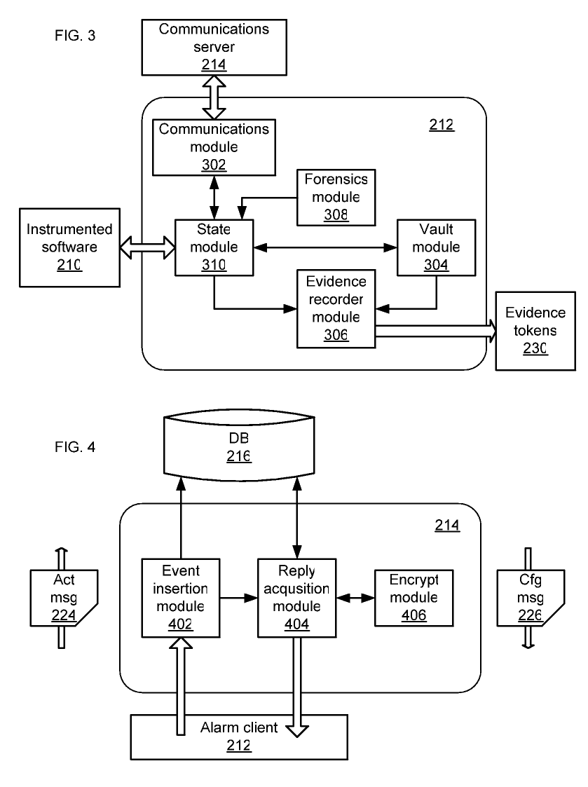

FIG. 3-6 show additional details of the four primary components, the alarm client 212, the communications server 214, the database 216, and the management server 218, respectively, of the embodiment of the software alarming system 200 in FIG. 2a-b.

FIG. 3 is a block diagram depicting how the alarm client 212 can be implemented with five primary modules: a communications module 302, a vault module 304, an evidence recorder module 306, a forensics module 308, and a state module 310.

Summarizing first, the alarm client 212 implements the instrumentation stage 202 of the software alarming system 200, and thus is responsible for preparing and communicating the activity messages 224 to the communications server 214 when an end user attempts to perform an operation using the instrumented software 210. The alarm client 212 can be integrated directly into the instrumented software 210 (as a library in C++, for instance) and performs a variety of functions, from storing and transmitting unique identification messages, to examining the local machine for forensics data in the forensics mode. The alarm client 212 can be capable of communicating with the communications server 214 despite intervening firewalls and it can deposit evidence tokens 230 on a local machine in a variety of locations.

The communications module 302 is responsible for transmitting the activity message 224 to and receiving the configuration messages 226 back from the communications server 214. The activity messages 224 to the communications server 214 can be packaged as HTTP Post commands, thus allowing them to be communicated through most firewalls. Similarly, responses can be returned by the communications server 214 to the alarm client 212 as web page responses to such Post requests. The communications module 302 can also be responsible for verifying a digital signature block provided with a configuration message 226, to confirm that it was in fact sent by the communications server 214 and to thus thwart one way that miscreants might attempt to potentially undermine the alarm client 212. The communications module 302 is utilized directly by the state module 310.

The vault module 304 is responsible for securely storing information on the local machine where the instrumented software 210 is run, such as generic unique ID numbers, license keys, etc. It can store this information in a compressed format in a variety of locations for robustness and security, including LSA Secrets (if available), the system registry, and the file system. The vault module 304 is utilized by the state module 310, for caching information locally, and also utilized by the evidence recorder module 306, which uses it to determine one set of locations for storing evidence tokens 230.

The evidence recorder module 306 is responsible for depositing evidence tokens 230 on the local machine, and thus providing a robust record of the activity of the instrumented software 210. These evidence tokens 230 may later be used to illustrate that the instrumented software 210 was in fact utilized on the local machine, even if the instrumented software 210 is subsequently deleted by the infringing user. The evidence recorder module 306 uses the vault module 304 as one location for storage, but can also store the evidence tokens 230 in other locations. The evidence recorder module 306 is accessed directly by the state module 310.

The forensics module 308 is responsible for discovering and identifying information about the local machine, and about the local user in the event of infringement. When an “enhanced” or “forensics” mode is activated on the alarm client 212, the forensics module 308 investigates the local machine to determine the identifying information to establish a case of infringement. The forensics module 308 is activated by and reports its results to the state module 310.

The state module 310 is responsible for coordinating the activities of the other four modules 302, 304, 306, 308, for interpreting messages from the communications server 214, and for providing an interface to the instrumented software 210. In particular, the state module 310 maintains the alarming state of the instrumented software 210. That is, whether or not the alarm client 212 is in enhanced mode, what sort of data should be sent to the communications server 214, and whether or not the instrumented software 210 should be allowed to run at all or should be re-tasked, as dictated ultimately by the management server 218. The state module 310 utilizes the communications module 302 to communicate with the communications server 214, and the vault module 304 to store its state between executions of the instrumented software 210.

FIG. 4 is a block diagram depicting how the communications server 214 can be implemented with three primary modules: an event insertion module 402, a reply acquisition module 404, and an encryption module 406.

Summarizing first, the purpose of the communications server 214 is to connect the alarm client 212 and to the database 216. Because the alarm client 212 can communicate entirely with HTTP Post commands, the communications server 214 can be implemented entirely in active server pages (ASP) and using component object model (COM) technology and can run on a standard web server as an extremely lightweight package. This ensures that the software alarming system 200 is extremely fast and simple to maintain, and scales well with the large-scale deployment of the instrumented software 210. The communications server 214 can also be implemented as an entirely stateless system, relying on the database 216 for all of its information storage needs.

The event insertion module 402 receives the activity messages 224 from the alarm client 212 and breaks them down into component elements that it inserts it into chronological event record tables (described presently) in the database 216. The event insertion module 402 is also responsible for determining any desired message-based components for the event record for each activity message 224, such as the source internet address, the route taken, a timestamp of receipt, etc. Once an activity message 224 and any related data for it have been inserted into the database 216, the activity message 224 is also passed to the reply acquisition module 404.

The reply acquisition module 404 queries the database 216 after an activity message 224 has been received by the communications server 214, to determine if any configuration messages 226 should be sent back to the alarm client 212. Note that the reply acquisition module 404 is not responsible for determining what the contents of configuration messages 226 should be; it simply reads any pre-determined configuration messages 226 from a response table in the database 216, according to the identifying information contained in the activity message 224. The contents of a configuration message 226 are dictated by the management server 218. Because configuration messages 226 are predefined with respect to the communications server 214, the reply acquisition module 404 can be very fast. Once a configuration message 226 has been acquired by the reply acquisition module 404 it is passed to the encryption module 406 for signing before being sent onward to the alarm client 212.

The encryption module 406 appends a digital signature block to each configuration message 226, enabling the alarm client 212 to confirm that a configuration message 226 did come from the communications server 214.

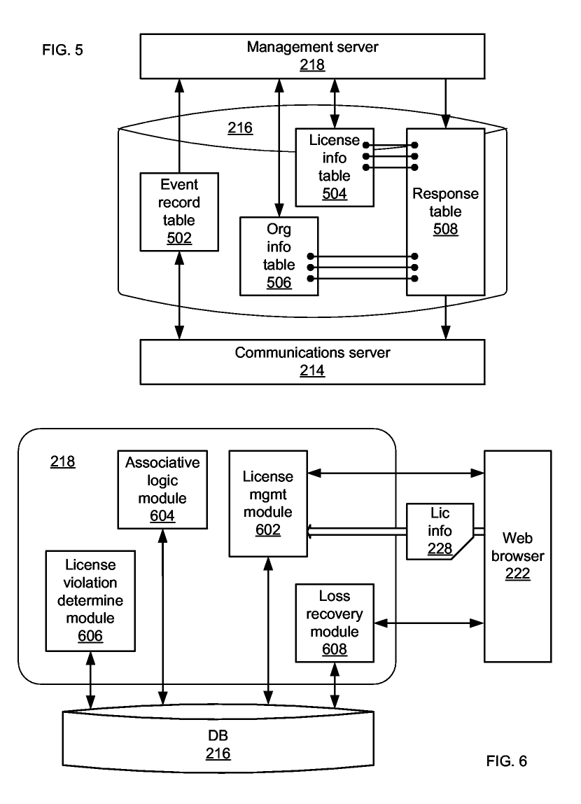

FIG. 5 is a block diagram depicting how the database 216 can be implemented with four primary tables: a chronological event record table 502, a licensing information table 504, an organizational information table 506, and a response table 508.

Summarizing first, the database 216 is responsible for storing all information provided to it from the communications server 214 (particularly including that collected by the alarm client 212) as well as any information provided to it by the management server 218. The database 216 is also responsible for storing an alarming state of any given organization, installation, network address, or user of the instrumented software 210 (e.g., NORMAL, ENHANCED, TERMINATED, etc.), and for holding a queue of any configuration messages 226 to be sent to the alarm clients 212 as each next connects to the communications server 214. Because the database 216 can be made responsible for holding the entire state of the software alarming system 200, it can contain no actual logic, only data tables. The database 216 can be implemented as a SQL Server database that is queried and updated by the communications server 214 and the management server 218.

The event record table 502 is the final repository of the data collected by the alarm client 212, and stores all of the information transmitted from it or added by the communications server 214. The management server 218 cross-references data from the event record table 502 with data stored in the licensing information table 504 and the organizational information table 506 to determine whether or not infringement has occurred. The event record table 502 is updated only by the communications server 214, and then queried only by the management server 218.

The licensing information table 504 can contain information pertaining to all known license keys, including the identity of licensees and the terms of licenses (for legal keys) as well as the source of the key (for pirate keys). As new keys are created or discovered, they are inserted into the licensing information table 504. The licensing information table 504 also holds license usage information, which the management server 218 cross-references with the data stored in the event record table 502 and the organizational information table 506 to detect infringement. Each entry in the licensing information table 504 has an associated entry in the response table 508, which the communications server 214 can access to determine what configuration message 226 to respond with to any given alarm client 212. The licensing information table 504 is updated and queried by the management server 218.

The organizational information table 506 contains information on the entities (e.g., corporations, organizations, individuals, etc.) that have licensed the instrumented software 210 or who are known to be using it in an infringing manner. As new users of the instrumented software 210 are discovered or licensed, the organizational information table 506 is updated. The organizational information table 506 also contains information on the current state of these entities, such as, whether they are legal users, are in collections, etc. Each entry in the organizational information table 506 has an associated entry in the response table 408, which the communications server 214 can access to determine what configuration message 226 to respond with to any given alarm client 212. The organizational information table 506 is updated and queried by the management server 218.

The response table 508 contains the configuration messages 226 that should be sent to any alarm client 212 associated with a particular network address, entity, license key, or unique ID. Each entry in the licensing information table 504 and the organizational information table 506 has a corresponding entry in the response table 508. The response table 508 is updated by the management server 218 based on its analysis of the data stored in the licensing information table 504, the organizational information table 506, and the event record table 502, and is queried by the communications server 214. Of course, using well-known techniques, the four primary tables 502, 504, 506, and 508 of the database 216 can be normalized into a larger number of tables for the purpose of increasing efficiency in data storage.

FIG. 6 is a block diagram depicting how the management server 218 can be implemented with four primary modules: a license management module 602, an associative logic module 604, a license violation determination module 606, and a loss recovery module 608.

Summarizing first, the management server 218 is responsible for monitoring and managing the information collected by the instrumentation systems, for detecting infringement, for managing the pursuit of lost revenues, and for generally controlling all aspects of the software alarming system 200. The management server 218 is the most complex of the server-side components and is the interface primarily used by the software manufacturer to recover lost revenues or to build a case for court. For maximum accessibility, the management server 218 can be implemented in ASP and COM, and thus can run in a standard web server environment. This allows maximum flexibility in managing software licensing and instrumentation.

The license management module 602 is responsible for creating and managing valid license keys, adding newly-discovered crack keys, and ensuring that all license usage information is appropriately stored in the database 216. The license management module 602 updates the licensing information table 504 in the database 216 on a regular basis, either when a new key is discovered to be operating (e.g., a new crack key) or when a new key is generated using the license management module 602 (a legal key). The license management module 602 can be directly accessed by the employees of the manufacturer of the instrumented software 210 to allow them to construct new, valid license keys. This can be done using a conventional web browser 222.

The associative logic module 604 is responsible for associating various values of identifying information with specific entities. Thus, the associative logic module 604 connects generic unique ID numbers, network addresses, license keys, and other information with the entities that own them or that they represent. This association allows the license violation determination module 606 and the loss recovery module 608 to accurately track the recorded behavior and identify any infringement that exists. The associative logic module 604 accesses the event record table 502, the licensing information table 504, and the organizational information table 506, and stores information in the organizational information table 506.

The license violation determination module 606 is responsible for detecting a potential case of infringement by comparing the usage information recorded in the event record table 502 with the parameters for legal usage stored in the licensing information table 504. Once a suspected case of infringement has been detected, the license violation determination module 606 updates the organizational information table 506, allowing employees of the manufacturers of the instrumented software 210 to review the case with the license violation determination module 606 before proceeding to take formal action.

The loss recovery module 608 provides the interface with which the employees of the manufacturer of the instrumented software 210 is able to activate the forensics mode, to pursue lost revenues, and to deactivate specified installations of the instrumented software 210, if desired. The loss recovery module 608 allows such users of the software alarming system 200 to examine the data in all of the tables of the database 216, and it updates the organizational information table 506 and the response table 508 as appropriate.

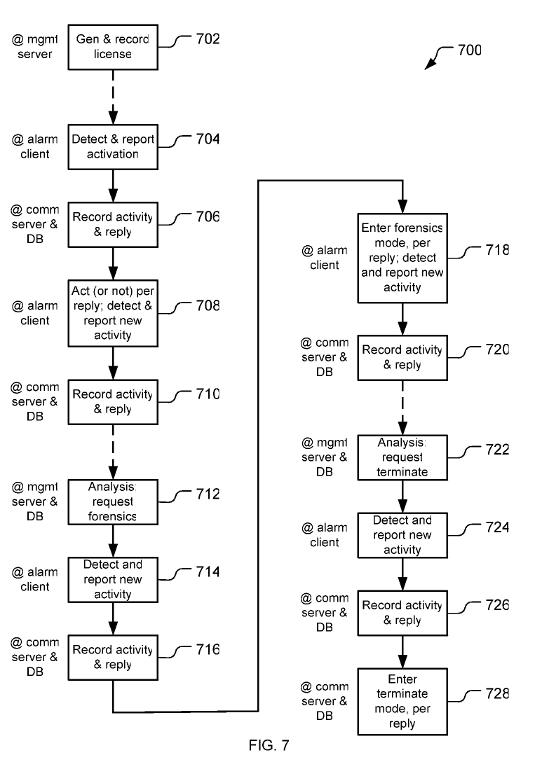

FIG. 7 is flow chart depicting a chronological overview of a process 700 using the software alarming system 200 in an exemplary usage scenario.

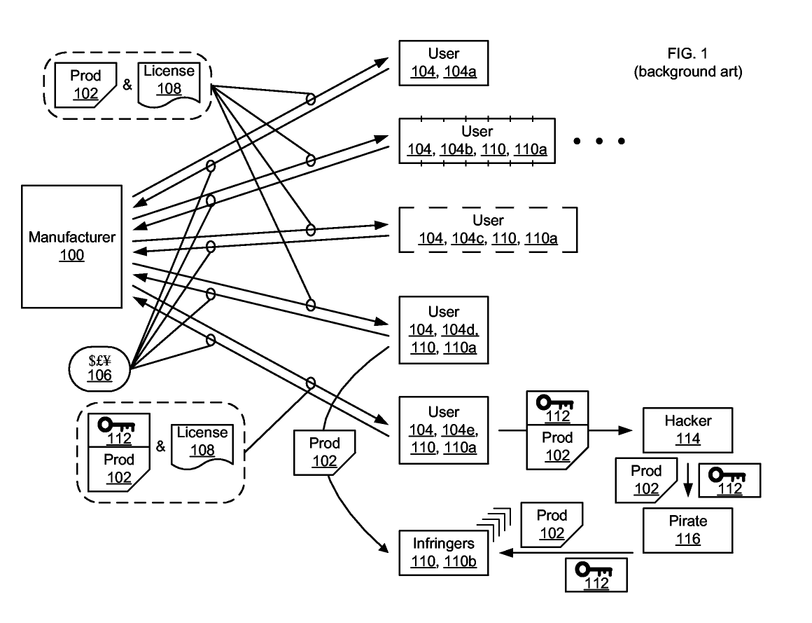

In a step 702, the management server 218 is activated by an employee of a software manufacturer 100 to license the use of ten instances of the instrumented software 210. For this, the employee uses the license management module 602 to create a license key 112 (an anti-piracy mechanism 112 in FIG. 1) for a specific licensee organization in accordance with a license 108. The license management module 602 then updates the licensing information table 504 in the database 216 with the new license key 112.

In a step 704, at some later time, the alarm client 212 detects that an end user 104 has activated an instance of the instrumented software 210 with the license key 112. The state module 310 now reads cached information from a previous activation of the instrumented software 210 which was stored in the vault module 304 and determines that it is authorized to start the instrumented software 210. Additionally, the communications module 302 sends an activity message 224 to an accessible communications server 214, reporting that the instrumented software 210 has been activated using the license key 112.

In a step 706, the communications server 214 receives the activity message 224 and uses its event insertion module 402 to update the event record table 502 in the database 216 with appropriate information based on the activity message 224. The reply acquisition module 404 then queries the response table 508 of the database 216 for any entries there for the license, user 104, network address, other unique ID, etc. Finding no specific configuration message 226 waiting, the reply acquisition module 404 generates an empty configuration message 226, signs it with the encryption module 406, and returns that configuration message 226 to the alarm client 212. [Note, the use of empty configuration messages 226 is optional.]

In a step 708, the alarm client 212 receives the configuration message 226 at its communications module 302, confirms that the signature on it is from the communications server 214, and passes the empty configuration message 226 to the state module 310. The state module 310 parses the empty configuration message 226. Because the configuration message 226 is empty, the state module 310 takes no additional action at this time.

At some later time, the alarm client 212 detects that the end user 104 has performed an operation using the instrumented software 210. The state module 310 accordingly uses the communications module 302 to update the communications server 214 about this, by sending it another activity message 224.

In a step 710, the communications server 214 receives this latest activity message 224 and uses its event insertion module 402 to update the event record table 502 of the database 216. The reply acquisition module 404 also queries the response table 508 of the database 216 for any outstanding configuration messages 226. Finding nothing, the state module 310 again simply returns an empty, signed configuration message 226 to the alarm client 212.

In a step 712, at some later time, the management server 218 becomes active. Using its associative logic module 604, it determines that our new end user 104 here is actually part of the original licensed organization and it updates the organizational information table 506 in the database 216 to indicate that this user's unique installation ID is associated with that organization.

The license violation determination module 606 then counts the number of machines in use by that organization and finds 11—an apparent case of under-licensing. The license violation determination module 606 accordingly updates the organizational information table 506 of the database 216 to indicate that the organization is potentially infringing its license (i.e., that is an infringer 110a that is defrauding the software manufacturer 100).

At some still later time, an employee of the software manufacturer 100 activates the loss recovery module 608 and is informed that the organization has exceeded its licensed number of instances of the instrumented software 210. The employee then decides to pursue the lost revenue, and instructs the loss recovery module 608 to activate the forensics mode to acquire more specific information identifying the user 104. The loss recovery module 608 accordingly updates the response table 508 of the database 216, by storing a configuration message 226 there that requests the alarm client 212 at the infringing instrumented software 210 to enter forensics mode.

In a step 714, yet later, the alarm client 212 detects that the user 104 is attempting to perform another operation using the instrumented software 210. The alarm client 212 accordingly sends another activity message 224 to the communications server 214.

In a step 716, the communications server 214 receives this latest activity message 224. Using its reply acquisition module 404, it queries the response table 508 of the database 216 for any outstanding configuration messages 226. At this time, the reply acquisition module 404 finds the stored configuration message 226, signs it with the encryption module 406, and returns it to the alarm client 212.

In a step 718, the alarm client 212 receives the configuration message 226 requesting forensics mode, and its communications module 302 verifies the signature and passes the configuration message 226 to the state module 310. The state module 310 then enters the forensics mode and stores its current state in the vault module 304 and in the evidence recorder module 306.

The alarm client 212 next uses its forensics module 308 to query the system on which the instrumented software 210 is running for identifying information, and the state module 310 packages this into yet another activity message 224 which is sent to the communications server 214.

In a step 720, the communications server 214 receives the activity message 224 with the identifying information and updates the event record table 502 of the database 216 with this information. [Note, operations of the instrumented software 210 are simply allowed to continue as normal at this point.]

In a step 722, at some later time, the management server 218 is again activated by an employee of the software manufacturer 100. Using the loss recovery module 608, the employee now investigates the status of the ongoing investigation and the associative logic module 604 finds the new identifying information and displays it to the employee.

For the sake of this example, the employee here proceeds to attempt to collect the lost revenue for the illegal use of the 11th instance of the instrumented software 210, and the organization fraudulently using the instrumented software 210 in an infringing manner here refuses to settle. The employee therefore opts to terminate the instrumented software 210 in accordance with the terms of the license 108. For this, he or she instructs the loss recovery module 608 to deactivate the 11th installation, and the loss recovery module 608 updates the response table 508 of the database 216, storing a configuration message 226 there requesting deactivation of the 11th instance of the instrumented software 210.

In a step 724, at some later time, the alarm client 212 detects that the user 104 is attempting to perform another operation using the instrumented software 210. The alarm client 212 accordingly sends another activity message 224 to the communications server 214.

In a step 726, the communications server 214 receives this latest activity message 224. In response to this, its reply acquisition module 404 retrieves the configuration message 226 from the database 216, signs it using its encryption module 406, and sends the configuration message 226 onward to the alarm client 212.

In a step 728, the alarm client 212 receives the configuration message 226, uses its communications module 302 to verify it, and passes it to the state module 310. The state module 310 records the request for deactivation of the instrumented software 210 in the vault module 304 and the evidence recorder module 306, and proceeds to shut down the infringing instance of the instrumented software 210.

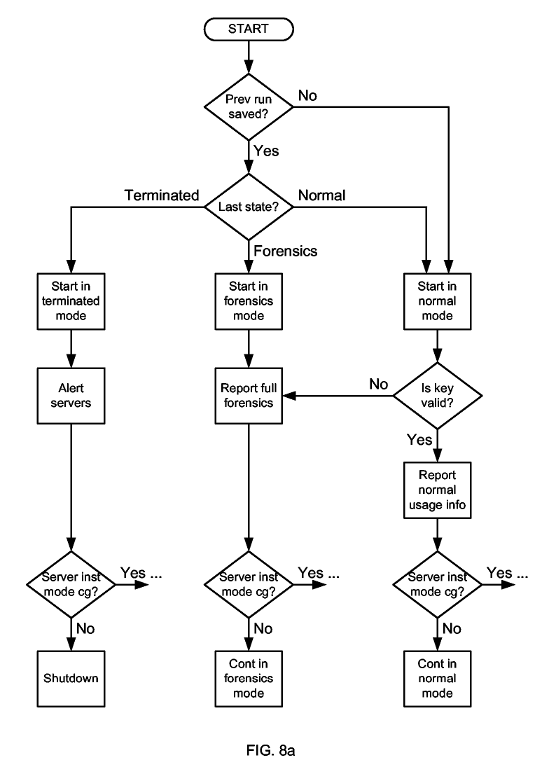

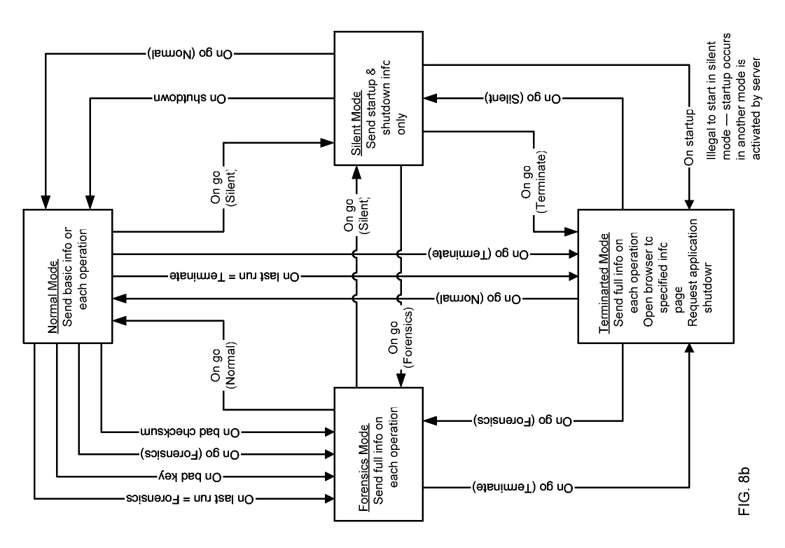

FIG. 8a-b depict how the alarm client 212 may be embodied as a state machine. As has already been noted, even the forensics mode is optional. It and other modes are, however, useful in some applications, and FIG. 8a-b therefore depict a sophisticated embodiment of the alarm client 212 employing a “NORMAL,” “FORENSICS,” TERMINATED,” and “SILENT” modes. FIG. 8a is flow chart depicting how these states are selected, and FIG. 8b is a state diagram of the transitions between these modes. The normal and forensics modes have already been discussed, and the terminated mode is largely self evident. The silent mode here can particularly be selected and used when the status of a given installation of the instrumented software 210 is known. For instance, if an installation is presently classed as non-infringing, use of the silent state minimizes any possible burden or obtrusive effects by the alarm client 212. Similarly, if an installation is presently classed as infringing and an adequate amount of forensics evidence has already been collected, use of the silent state minimizes the possibility of detection while other activities occur. For instance, the alarm clients 212 in known infringing instances of the instrumented software 210 in an organization can be put into the silent mode while monitoring for other instances continues or while forensics are collected from such installations in that organization.

While various embodiments have been described above, it should be understood that they have been presented by way of example only, and not limitation. Thus, the breadth and scope of the present invention should not be limited by any of the above described exemplary embodiments, and should only be defined in accordance with the following claims and their equivalents.

### INDUSTRIAL APPLICABILITY

The present software alarming system 200 is well suited for application to combat software piracy. Such piracy is an ongoing problem that nearly every software company faces today. The current state of the art in combating it, key verification, has proven ineffective and, in fact, many companies are entirely helpless when it comes to protecting their intellectual property. With as much as 20-30% of their revenues lost each year to piracy, a new solution has been much needed and in this invention the inventors have created a new technique, Software Alarming, which is significantly more effective at detecting software piracy, measuring the scope of it, and recovering what would otherwise be revenues lost because of it.

The present software alarming system 200 is a particularly effective solution to software piracy, comprehensively encompassing, as has been described herein, stages for instrumentation, monitoring, and action.

For the above, and other, reasons, it is expected that the software alarming system 200 of the present invention will have widespread industrial applicability and it is therefore expected that the commercial utility of the present invention will be extensive and long lasting.

What is claimed is:

1. An instrumentation for alarming a software product that is subject to a license, comprising:
an alarm client incorporated with the software product;
said alarm client to collect usage information about the software product while it runs on a computer, wherein said usage information permits determining whether the software product is being used in accord with the license; and
said alarm client further to communicate an activity message including said usage information to a remote server via a communications network.

2. The instrumentation of claim 1, wherein said alarm client determines whether a selected operation is performed or not performed while the software product runs and said alarm client includes event data about said operation in said activity message.

3. The instrumentation of claim 2, wherein said operation is activation of the software product on said computer.

4. The instrumentation of claim 2, wherein said operation is altering or disabling a portion of the software product or said alarm client.

5. The instrumentation of claim 2, wherein said alarm client includes a unique identifier for said event data in said activity message, thereby permitting correlation of multiple instances of said event data or multiple said activity messages.

6. The instrumentation of claim 1, wherein said alarm client includes in said activity message at least one of a license key under which the software product was activated, user data which the software product was activated, and organization data under which the software product was activated.

7. The instrumentation of claim 1, wherein said alarm client periodically determines activity of the software product on said computer and includes event data about said activity in said activity message.

8. The instrumentation of claim 7, wherein said alarm client includes in said activity message an identifier of at least one of an end-user running the software product and said computer running the software product.

9. The instrumentation of claim 8, wherein said identifier is a login name of said end-user.

10. The instrumentation of claim 8, wherein said identifier is a unique value representing said end-user but not specifically identifying them by name.

11. The instrumentation of claim 1, wherein said alarm client receives an instruction from said server specifying at least one of what said usage information to include in said activity message and how to communicate said activity message via said communications network.

12. The instrumentation of claim 11, wherein said alarm client determines what said usage information to include in said activity message based on a license key under which the software product was activated.

13. The instrumentation of claim 12, wherein said determination is made based on a heuristic or algorithmic analysis of said license key.

14. The instrumentation of claim 1, wherein said alarm client is able to selectively impede or terminate running of the software product.

15. The instrumentation of claim 14, wherein said alarm client receives an instruction from said server specifying that the software product be terminated or impeded.

16. The instrumentation of claim 1, wherein:
said alarm client determines whether an attempt to communicate said activity message was successful; and
if not, said alarm client retries communicating said activity message using at least one of increasing the frequency of efforts to communicate said activity message, using an alternate said server, using an alternate parameter for communicating via said communications network, and using an alternate said communications network.

17. The instrumentation of claim 1, wherein:
said alarm client determines whether an attempt to communicate said activity message was successful; and
if not, said alarm client impedes or terminates running of the software product.

18. A method for monitoring a software product subject to a license, comprising:
collecting usage about the software product while the software product runs on a computer, wherein said usage information permits analysis to determine whether the software product is being used in accord with the license; and
communicating an activity message including said usage information to a remote server via a communications network.

19. The method of claim 18, further comprising:
determining whether a selected operation is performed or not performed while the software product runs; and
including event data about said operation in said activity message.

20. The method of claim 19, wherein said operation is activation of the software product on said computer.

21. The method of claim 19, wherein said operation is altering or disabling a portion of the software product or said instrumentation.

22. The method of claim 19, further comprising including a unique identifier for said event data in said activity message, thereby permitting correlation of multiple instances of said event data or multiple said activity messages.

23. The method of claim 18, further comprising including in said activity message at least one of a license key under which the software product was activated, user data under which the software product was activated, and organization data under which the software product was activated.

24. The method of claim 18, further comprising:
periodically determining activity of the software product on said computer; and
including event data about said activity in said activity message.

25. The method of claim 24, further comprising:
collecting an identifier of at least one of an end-user running the software product and said computer running the software product; and
including said identifier in said activity message.

26. The method of claim 25, wherein said identifier is a login name of said end-user.

27. The method of claim 25, wherein said identifier is a unique value representing said end-user but not specifically identifying them by name.

28. The method of claim 18, further comprising receiving an instruction from said server specifying at least one of what said usage information to include in said activity message and how to communicate said activity message via said communications network.

29. The method of claim 28, further comprising determining what said usage information to include in said activity message based on a license key under which the software product was activated.

30. The method of claim 29, further comprising basing said determination on a heuristic or algorithmic analysis of said license key.

31. The method of claim 18, further comprising selectively impeding or terminating running of the software product.

32. The method of claim 31, further comprising receiving an instruction with a selection from said server.

33. The method of claim 18, further comprising:
determining whether said communicating of said activity message was successful; and
if not, re-communicating said activity message using at least one of increasing the frequency of efforts to communicate said activity message, using an alternate said server, using an alternate parameter for communicating via said communications network, and using an alternate said communications network.

34. The method of claim 18, wherein:
determining whether said communicating of said activity message was successful; and
if not, impeding or terminating running of the software product.
